(19) United States
(12) Patent Application Publication
(10) Pub. No.: US 2008/0106359 A1
(43) Pub. Date: May 8, 2008

(54) BREAKER

(76) Inventor: Chiu-Yueh Chang, Taipei (TW)

Correspondence Address: Chiu-Yueh Chang, 235 Chung - Ho, Box 8-24, Taipei, omitted

(21) Appl. No.: 11/856,070

(22) Filed: Sep. 17, 2007

(30) Foreign Application Priority Data
Nov. 8, 2006 (TW) 095219730

(51) Int. Cl. H01H 83/00; H01H 83/12

(52) U.S. Cl. 335/20

(57) ABSTRACT

A breaker connected between a power source end of an electric device and a power source comprises a power retriever for setting a first reference voltage; the first reference voltage being corresponding to a limiting value; a comparator for comparing a first reference voltage and a second reference voltage value; the second reference voltage value being corresponding to a power used in the electric device; a timer; when the second reference voltage value being smaller than the first reference voltage; the timer determining whether a counting time period is over a breaking time; and a switch; if the time period is over the breaking time, the switch will turn off a connection between a power source end of the electric device and the power source.

### FIELD OF THE INVENTION

The present invention relates to breakers, and particularly to a breaker which can reduce the power consumption as an electric device is in standby state, while the user is unnecessary to withdraw a plug. Furthermore the short circuit is avoided.

### BACKGROUND OF THE INVENTION

With the improvement of electronic technologies, more and more electric devices are used in daily life, such as TVs, microwave ovens, air conditioners, etc. All these are used almost in every home. However, generally, when these devices are not used, the plugs of these devices are retained in the receptacle. However, this will induce power consumption. Statistically, the power consumption for TV in standby is about 0.1 to 4.2 watts, for microwave ovens, is about 0.1 to 4.2 watts, for stereos, is about 0.04 to 14.9 watts. In one year, 300 kilowatt-hours are needs for one home.

Although governments propagate to withdraw plugs as the electric devices are not used, the effect is not good, because it is very inconvenient, even the plug is easily damaged or for a long time, the plug can not be well engaged with the receptacle.

In summary, for saving power, and avoiding the plugs and receptacles are damaged, a novel device which can isolate electric power in standby state is necessary.

### SUMMARY OF THE INVENTION

Accordingly, the primary object of the present invention is to provide a breaker which can reduce the power consumption as an electric device is in standby state, while the user is unnecessary to withdraw a plug. Furthermore the short circuit is avoided.

To achieve above objects, the present invention provides a breaker connected between a power source end of an electric device and a power source, comprises a power retriever for setting a first reference voltage; the first reference voltage being corresponding to a limiting value; a comparator for comparing a first reference voltage and a second reference voltage value; the second reference voltage value being corresponding to a power used of the electric device; a timer; when the second reference voltage value being smaller than the first reference voltage; the timer determining whether a counting time period is over a breaking time; and a switch; if the time period is over the breaking time, the switch will turn off a connection between a power source end of the electric device and the power source.

The various objects and advantages of the present invention will be more readily understood from the following detailed description when read in conjunction with the appended drawing.

### BRIEF DESCRIPTION OF THE DRAWINGS

FIG. 1 shows the circuit diagram of the first embodiment of the breaker of the present invention.

FIG. 2 is a schematic view about the second embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

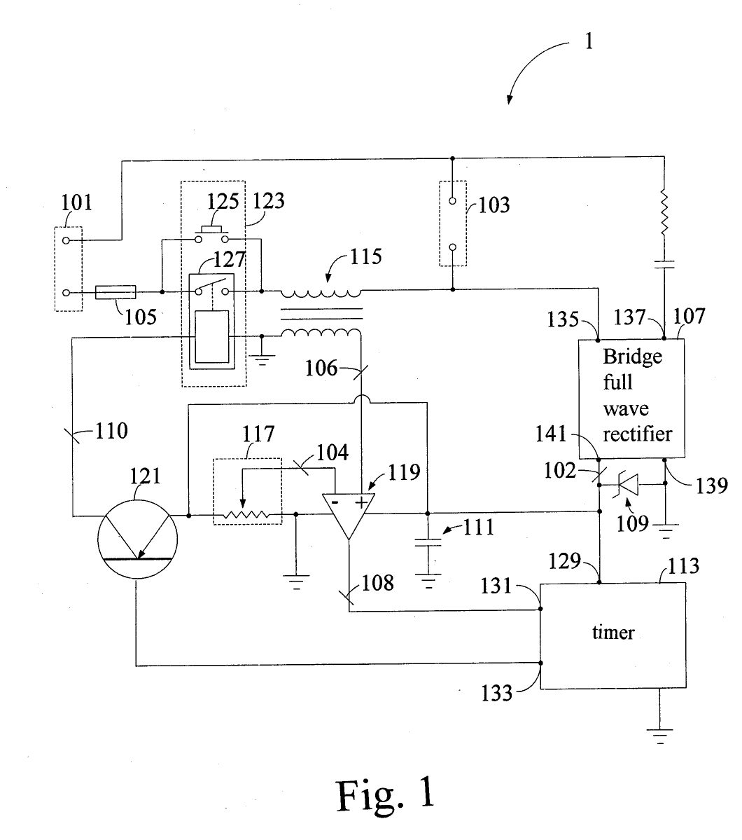

Referring to FIG. 1, the breaker 1 of the present invention is illustrated. The breaker 1 of the present invention is suitable for any electronic device. The breaker 1 is connected between a power source and a power source end of an electric device. The breaker 1 is installed in an interior of an electric device. The power source end connected to the breaker 1 is connected to a control circuit in the electric device. The control circuit receives a signal to actuate or turn off the electric device. The electric device receives power through the breaker 1. The breaker 1 includes an input end 101, an output end 103, a fuse 105, a bridge full wave rectifier 107, a Zener diode 109, a filter capacitor 111, a timer 113, a transformer 115, a power retriever 117, comparator 119, a transistor 121, and a switch 123. The switch 123 includes a button 125 and a relay 127. The timer 113 includes a power source end 129, reset end 131, and an output end 103. The connections of all the elements are illustrated in FIG. 1.

A plug of the electric device is connected to a receptacle for having an alternative current of 110 Volts. The alternative current is inputted from the input end 101. After inputting the alternative current, the current flows through the fuse 105 for preventing from over-current so as to protect the circuit.

When the user desires to start the electric device, firstly, the user presses the button 125, and then presses the switch of the electric device for actuating the control circuit in the electric device and thus the electric device starts. Then alternative current outputs from the output end 103 to the control circuit of the electric device for supplying electric power. Meanwhile, the current is transferred to the bridge full wave rectifier 107. In this embodiment, the bridge full wave first input end 135, a second input end 137, a ground end 139 and an output end 141. The bridge full wave rectifier 107 receives the alternative current of 110 volts through the first input end 135 and the second input end 137. The alternative current is rectified through an internal diode. Then a direct current 102 of 12 volts is outputted from the output end 141 of the bridge full wave rectifier 107. Thus, the bridge full wave rectifier 107 has the effect of converting the alternative current of 110 Volts to the direct current 102 of 12 Volts.

The Zener diode 109 has the effect of stabilizing the voltage of the direct current 102 of 12 volts outputted from the bridge full wave rectifier 107. After the current is filtered by the filter capacitor 111, the direct current 102 flows to the power source end 129 as the current source of the timer 113 and also to the power source end of the comparator 119 as the power source of the comparator 119. Thereby the direct current 102 also flows to the power retriever 117 and the emitter of the transistor 121, wherein the transistor 121 is a PNP transistor.

In this embodiment, the power retriever 117 includes a variable resistor (variator) and the comparator 119 may be an OP amplifier. The transformer 115 transfers the voltage to the electric device into a voltage suitable for the OP amplifier (operation amplifier). This voltage is as a second reference voltage value 106. The variator of the power retriever 117 provides a first reference voltage 104 to the OP amplifier. The first reference voltage 104 is corresponding to a preset power limiting value which is changeable by adjusting the variator. In this embodiment, we assume that the standby power of this electric device is 3 Watts. The power of the electric device is 7 Watts. Thus, the first reference voltage 104 can be adjusted properly so that the corresponding power limiting value is 5 watts. The OP amplifier serves to compare the first reference voltage 104 with the second reference voltage value 106. Because the electric device is now used, thus the power of the electric device is greater than the power limiting value. Thus, the second reference voltage value 106 will great than the first reference voltage 104. The OP amplifier will output a high level reset signal 108 to the reset end 131 of the timer 113. Then the timer 113 receives this high level reset signal 108, it will reset the timer 113 continuously.

Since the timer 113 is reset continuously, the time of the timer 113 is not greater than a preset power-off time in the timer 113, for example, 10 minutes. The output end 133 of the timer 113 will output a lower level signal to the base of the transistor 121. Then the transistor 121 will conduct. The current 110 will flow through the collector of the transistor 121 to the relay 127 of the switch 123 so as to conduct the relay 127, even the button 125 is not pressed, it still retains the conduction of the interior of the breaker 1. In summary, in use, the second reference voltage value 106 will be greater than the first reference voltage 104 continuously. The comparator 119 will output rest signals 108 continuously so that the timer 113 rests continuously. The counting time is not greater than the breaking time of the timer 113 and thus the breaker 1 will supply power continuously.

When the user does not use this electric device, the user will press the switch of the electric device so as to turn off the electric device. The electric device will present a standby state. Then the alternative current 20 will output the current from the output end 103 and transfer the current to the bridge full wave rectifier 107. Similarly, the bridge full wave rectifier 107 will rectify the alternative current of 110 volts into direct current 102. The direct current 102 is stabilized by the second reference voltage value 106 and then is transferred to the timer 113, the power retriever 117, the comparator 119 and the emitter of the transistor 121.

When the OP amplifier compares the0 second reference voltage value 106 with the first reference voltage value 104, because the electric device is in a standby state, the second reference voltage value 106 is smaller than the first reference voltage 104. Then the OP amplifier will output a low level reset signal 108 to the reset end 131 of the timer 113. Then the timer 113 will be actuated.

When the time period of the timer 113 is greater than a preset breaking time in the timer 113, for example, 10 minutes, the output end 133 of the timer 113 will output a high level signal to the base of the transistor 121. The transistor 121 will turn off. Current can not flow to the relay 127 through the collector of the transistor 121. Thus, the relay 127 does not conduct. The breaker 1 is turned off. Thus no power is consumed as the transformer 115 is in standby state. The electric device is turned off completely.

If after the electric device is turned off, it is actuated in a preset time, since the output end 133 of the timer 113 is still in low level output state, after the relay 127 conducts, the electric device can work continuously.

If the user desires to open the electric device, he (or she) presses the button 125 so that the electric device is in the standby state. If it is not actuated in the turning off time period, the time period of the timer 113 will be greater than the preset breaking time. The breaker 1 will turn off.

In above mentioned embodiment, the bridge full wave rectifier 107 is one of the bridge full wave rectifier with a part No. RS405 produced by LerSan Wireless Co. Ltd, or a prior art bridge full wave rectifier with four diodes. The timer 113 is one of a 14 bits binary ripple counter with part number 4060 or 4020 produced by Fairchild Semiconductor Co., or a micro central processing unit, or a simple chip, or other integrated circuit with a counter or a timer.

In other embodiment, the breaker 1 may be used singly. The plug of the electric device is firstly inserted to the output end 103 of the breaker 1 and then the input end 101 of the breaker 1 is connected to the plug. The power source end of the electric device is connected to a power source through the breaker.

In other embodiment, the switch 125 is positioned at a remote controller of an electric device. When the button 125 is pressed, the signals from the button 125 will control the breaker 1 wirelessly. The way for transmitting signals is not confined in the present invention, for example, by supersonic waves, infrared rays, or others. The relay 127 may be a silicon controlled rectifier, SCR).

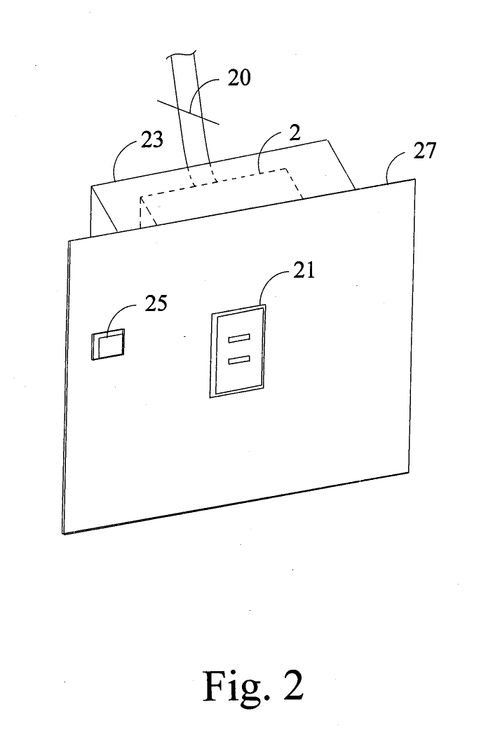

Referring to FIG. 2, the second embodiment of the present invention is illustrated. In this embodiment, one breaker 2 is installed to a wire box 23 of a receptacle 21 of an alternative current 20. The receptacle 21 is embedded into a wall. The alternative current 20 from the power company will transfer to the breaker 2 and then to the receptacle 21. When it is desired to use the electric device, it is only necessary to insert the plug into the receptacle 21. Thus, the electric device using the receptacle 21 saves power through the breaker 2. The button 125 of the switch (not shown) is installed in a receptacle panel 27 of the receptacle 21. Thus the user can use this device conveniently. Of course, those skilled in the art can install a breaker (as the breaker 1 or breaker 2) to a power supply of an electric device or is connected thereto internally or externally.

Other above mentioned two embodiments, in the present invention, the comparator and timer of the present invention can be realized mechanically. It can be a whole mechanical structure or only a part thereof is mechanic.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A breaker connected between a power source end of an electric device and a power source, comprising:
a power retriever for setting a first reference voltage; the first reference voltage being corresponding to a limiting value;
a comparator for comparing a first reference voltage and a second reference voltage value; the second reference voltage value being corresponding to a power used in the electric device;
a timer; when the second reference voltage value being smaller than the first reference voltage; the timer determining whether a counting time period is over a breaking time; and
a switch; if the time period is over the breaking time, the switch will turn off a connection between a power source end of the electric device and the power source.

2. The breaker as claimed in claim 1, wherein the first reference voltage is adjustable.

3. The breaker as claimed in claim 1, wherein the power limiting value is 10 watts.

4. The breaker as claimed in claim 1, wherein the power limiting value is 5 watts.

5. The breaker as claimed in claim 1, wherein the breaking time period is adjustable.

6. The breaker as claimed in claim 1, wherein the breaking time period is 10 minutes.

7. The breaker as claimed in claim 1, wherein the timer is a mechanic timer.

8. The breaker as claimed in claim 1, wherein the timer 113 is an electronic timer.

9. The breaker as claimed in claim 1, wherein the switch is one of a relay and a silicon controlled rectifier.

10. The breaker as claimed in claim 1, wherein the switch is a wireless controlled switch.

11. The breaker as claimed in claim 1, wherein the comparator is an OP amplifier.

12. The breaker as claimed in claim 1, wherein the power retriever is a variable resistor (variator).
